(19) United States
(12) Patent Application Publication
(10) Pub. No.: US 2006/0039345 A1
(43) Pub. Date: Feb. 23, 2006

(54) Method for optimizing energy consumption of a station in a wireless network

(75) Inventor: Xavier Perez-Costa, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, Tokyo (JP)

(21) Appl. No.: 11/206,808

(22) Filed: Aug. 19, 2005

(30) Foreign Application Priority Data
Aug. 19, 2004 (DE) 10 2004040405.4

(51) Int. Cl. H04J 3/16

(52) U.S. Cl. 370/346; 370/311

(57) ABSTRACT

A method to optimize the energy consumption of a station (STA)—as for example a laptop, palmtop or a mobile phone—in a network, preferably a WLAN according to the IEEE 802.11 standard where a station (STA) sending Power Save (PS) polls to an Access Point (AP) is characterized—regarding an efficient energy management of the station with a possibly low energy consumption—in that the Access Point (AP) confirms the receipt of a Power Save (PS) poll by sending an acknowledgement frame including information which indicates to the station (STA) whether a frame is stored for it at the Access Point (AP).

### BACKGROUND OF THE INVENTION

1. Field of the Invention

The present invention relates to a method of optimizing the energy consumption of a station (STA)—such as a laptop, palmtop or mobile phone, for example—in a network, preferably in a wireless LAN according to the IEEE standard 802.11, wherein a station (STA) sends Power Save (PS) polls to an access point.

2. Description of the Related Art

In wireless networks, mobile stations are generally battery operated. Since the energy consumption of mobile stations represents a critical performance factor, a special function is defined which supports the Power Save Mode (PSM) of mobile stations. The PSM as defined in the IEEE 802.11 standard introduces a dependency between the Beacon Interval (BI) and the downlink delay. Downlink delay is defined as the time starting from the point of time at which a frame is received at the Access Point (AP) at the MAC (Media Access Control) layer, until the point of time at which it is received successfully by a STA at the MAC layer. The Beacon Interval is the interval at which the Beacons are sent periodically by the AP. The dependency between BI and downlink delay can in case of some BI configurations result in the downlink delay exceeding a certain limit and therefore not being tolerable anymore for the respective application. In particular, this is critical in case of real-time applications like Voice over IP (VOIP).

Different modifications of the standard Power Save Mode can be taken into consideration in order to remove the dependency between the BI and the downlink delay. It can be provided, for example, that the transmission of PS-Polls is independent from the information contained in the Traffic Indication Map (TIM). See Japanese Patent Application No. 2003-046991 filed by the present applicant on Feb. 25, 2003 (Unexamined publication No. 2004-260386 published on Sep. 16, 2004).

Problems do occur in particular if an AP receives a PS-poll of a station without having buffered a frame for the station at the AP. It should be noted that—according to the Power Save Mode as defined in the IEEE 802.11 standard—it is provided that PS polls sent by a station to an AP are either confirmed by the receipt of a corresponding data frame or of an acknowledgement frame. Regarding the limited energy resources, it is in both cases disadvantageous that the station remains “awake” after sending the PS-poll or after receipt of the acknowledgement frame, i.e. it is in an operating state, and awaits the receipt of the data frame.

As a result, the energy saving efficiency is significantly decreased.

In order to avoid this problem, an additional frame, for example an empty data frame, can be sent or a timeout signal can be waited for. In both cases the delay is relatively long. Sending an empty data frame requires in addition that the system works in a mode which confirms at the AP the receipt of a PS-poll by directly sending the respective data frame. This mode is not the one usually used since the frames buffered in the PSM queue of the Access Point have the priority over the frames of other stations which are not in a Power Save Mode. In addition to this unfairness, it is disadvantageous that a malicious user could signal to the AP that it is in a Power Save Mode, but in fact he would stay awake sending PS polls all the time and hence, receiving frames quicker than other stations.

### SUMMARY OF THE INVENTION

The present invention focuses on a method to optimize the energy consumption of a station in a network of the aforesaid kind and by which—compared to the other known state-of-the-art methods—a higher level of energy saving for the station is achieved with simple means.

According to the present invention, a method to optimize the energy consumption of a station in a wireless network solves the aforementioned problem by the characteristics of claim 1. Such a method is characterized in that the Access Point (AP) confirms the receipt of a Power Save (PS) poll by sending an acknowledgment frame including some information indicating to the station (STA) whether a frame is buffered for it at the Access Point (AP).

According to the invention, it has first been recognized that a particularly efficient energy management for a station can be achieved by informing directly with the acknowledgement frame the station sending out a PS-poll saying whether there is a frame buffered for it at the Access Point.

The method according to the invention is characterized by its simplicity since only tools already available in the protocol of the IEEE standard 802.11 are used. Furthermore, it is advantageous that no additional frames, as for example empty data frames, are needed or a timeout has to be waited for. With the method according to the invention, the information can be sent immediately after the receipt of a PS-poll together with the acknowledgement frame, without having to wait for a free channel. Hence, as a result, the delay is minimized if compared to a solution with empty data frames or timeout signals and the efficiency in saving energy is therefore significantly increased.

It should be noted that the method according to the invention works for both of the aforementioned options of the AP to answer received PS-polls, i.e. it applies to the case that a sent PS-poll is confirmed by the receipt of a corresponding data frame, as well as to the case of a direct confirmation by an acknowledgement frame sent from an AP to the station.

The method according to the invention represents a safe mechanism which can be utilized for any kind of Power Save Modes, including the standard PSM, in order to cope with extraordinary situations in which a station sends a PS-poll and no frame is buffered at the AP for this station.

### BRIEF DESCRIPTION OF THE DRAWINGS

FIG. 1 is a schematic block diagram showing a wireless network according to an embodiment of the present invention;

FIG. 2 is a diagram showing a format of an acknowledgement frame used in the embodiment of the present invention;

FIG. 3A is a diagram showing an energy consumption optimizing operation in a station according to the embodiment of the present invention; and

FIG. 3B is a diagram showing a conventional power control operation in a station.

### DESCRIPTION OF THE PREFERRED EMBODIMENT

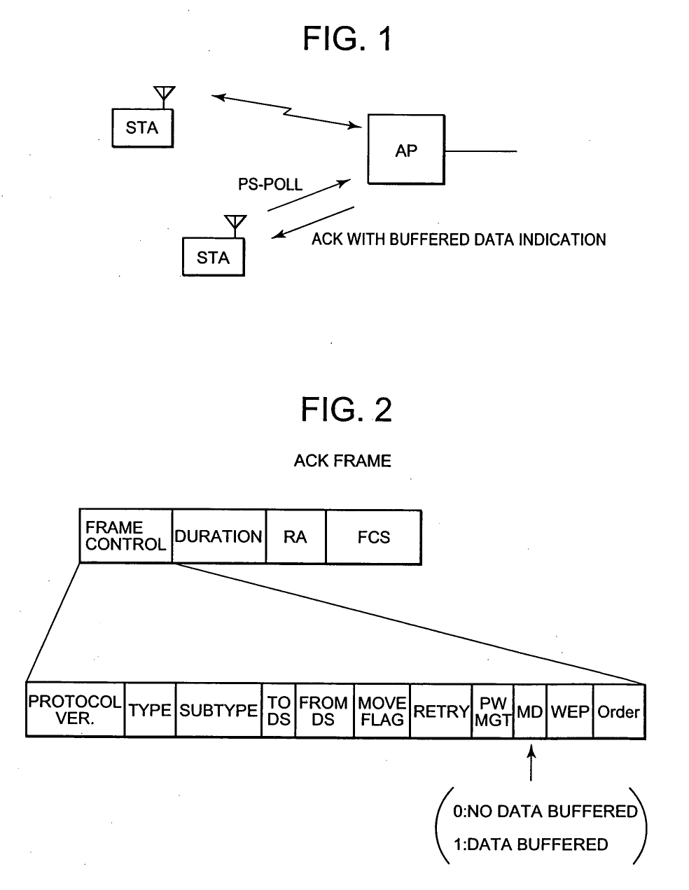

Referring to FIG. 1, a station (STA) operating in an energy saving mode transmits a PS-poll to an Access Point (AP) and, in response to the sent PS-poll, receives an acknowledgement (ACK) frame from the AP. The station is directly informed by information included in the ACK frame whether one or more frame for the station are buffered at the AP.

In a particularly preferred embodiment it is provided that the station changes to a “doze mode”, i.e. an energy saving mode, directly after having received the acknowledgement frame, if the information sent together with the acknowledgement frame shows that there are no frames buffered for the station at the Access Point. By doing so, the phase during which the station is “awake”, can be reduced to a minimum.

As shown in FIG. 2, in a preferable way, information indicating whether there is a frame for the station buffered at the Access Point, can be stored in the More Data (MD) field of the acknowledgement frame. The structure of the acknowledgement frame already defined in the standard, is not needed to be changed, only a field which was unused until now—the More Data field—, will be used.

The functionality of the station can be modified in such a way that it can interpret the More Data field of the acknowledgement frame. This can be realized with a minimum of effort because the operation to be performed by the station to interpret the More Data field of the acknowledgement frame is the same operation which the station performs for data frames as well.

In the context of a very simply implementable embodiment it is provided that the information is stored in a single bit of the More Data field. The changes to be performed at the Access Point in order to fill the More Data field of the acknowledgement frame are easy to realize. The operation to be done by the AP is the same as the operation which is performed by the AP in the context of the data frame in order to fill the More Data field there. Hence, the same structure as in the More Data field of a data frame is realized.

Concretely, as shown in FIG. 2, it can be provided that the bit in the More Data field is allocated the value 0 if there is no data frame buffered for the station at the Access Point. In return, the bit can be allocated the value 1 if one or more data frames are buffered for the station at the Access Point.

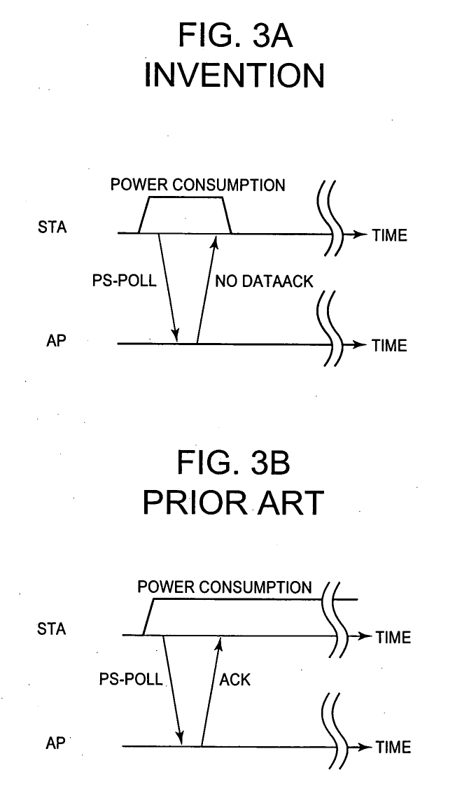

Referring to FIG. 3A, according to the embodiment, the station (STA) sends a PS-poll to the Access Point (AP) and then receives an acknowledgement frame (ACK) from the AP. When a value 0 is allocated to the More Data field of the ACK, which means that no data for the station is buffered in the Access Point, the station is controlled such that it is changed to the energy saving mode immediately after reception of the ACK, resulting in no further power consumption.

In contrast, as shown in FIG. 3B, in the case of a station having no power consumption optimizing function according to the present invention, the station keeps “awake” after the reception of the ACK with the More Data field having the value o allocated, resulting in continuing power consumption.

Finally, it should be noted that there are several possibilities to design and further develop the teaching of the present invention in a preferable manner for which the patent claims subordinate to claim 1 are to be referred to.

1. A method for optimizing energy consumption of a station in a network, comprising:
the station sending power save polls to an access point; and
the access point, in response to a power save poll received from the station, sending an acknowledgement frame back to the station to confirm reception of the power save poll, wherein the acknowledgement frame includes information which indicates to the station whether a frame is buffered for it at the access point.

2. The method according to claim 1, wherein the station changes immediately after receipt of the acknowledgement frame to an energy saving mode if the information sent together with the acknowledgement frame indicates that there is no frame buffered for the station at the access point.

3. The method according to claim 1, wherein the information is stored in a More Data field of the acknowledgement frame.

4. The method according to claim 3, wherein the station is modified in function so as to interpret the More Data field of the acknowledgement frame.

5. The method according to claim 3, wherein the information is stored in a single bit of the More Data field.

6. The method according to claim 3, wherein a bit in the More Data field is assigned a value 0 if no data frame is buffered for the station at the access point.

7. The method according to claim 3, wherein a bit in the More Data field is assigned a value 1 if one or more data frames are buffered for the station at the access point.

8. The method according to claim 1, wherein the station is a communication terminal which is one of a laptop, palmtop and a mobile phone.

9. The method according to claim 1, wherein the network is a wireless LAN according to IEEE standard 802.11.

10. A control method in a station which is operable in an energy saving mode and is allowed to connect to a network through an access point, comprising:
sending power save polls to the access point;
receiving an acknowledgement frame from the access point in response to a sent power save poll, wherein the acknowledgement frame includes information which indicates whether a frame is buffered for the station at the access point; and
controlling the energy saving mode based on the information included in the acknowledgement frame.

11. A method for optimizing energy consumption of a station in an access point, wherein the station is operable in an energy saving mode and is allowed to connect to a network through the access point, comprising:
receiving a power save poll from the station; and
sending an acknowledgement frame back to the station as a response to the power save poll, wherein the acknowledgement frame includes information which indicates to the station whether a frame is buffered for it at the access point, wherein the energy saving mode of the station is controlled based on the information included in the acknowledgement frame.
